(19) United States
(12) Patent Application Publication
(10) Pub. No.: US 2007/0046663 A1
(43) Pub. Date: Mar. 1, 2007

(54) Method of determining the shape of a dental technology object and apparatus for per-forming the method

(76) Inventors: Hartmut Brinkmann, Bohmte (DE); Stefan Fecher, Johannesberg (DE); Lothar Volkl, Goldbach (DE); Ralf Jaumann, Balingen (DE)

Correspondence Address: DENNISON, SCHULTZ & MACDONALD, 1727 KING STREET, SUITE 105, ALEXANDRIA, VA, 22314, US

(21) Appl. No.: 11/507,555

(22) Filed: Aug. 22, 2006

(30) Foreign Application Priority Data
Aug. 24, 2005 (DE) 10 2005 040 282.2
Oct. 11, 2005 (EP) 05 02 2072.2

(51) Int. Cl. G06T 15/00

(52) U.S. Cl. 345/419

(57) ABSTRACT

The invention relates to a method and an apparatus for a non-contact, three-dimensional determination of the shape of a dental technology object (10) whereby, to determine the space coordinates of the object's surface points to be measured, a thin stripe of light projected onto the object is measured by at least two matrix cameras (32, 34) to determine two space coordinates (Z- Y-coordinate) of a coordinate system, and the third space coordinate (X coordinate) is ascertained by determining the position of the object arranged on a measuring table (22) which is rotatable about an axis of rotation (20). For allowing, in an easy manner, a non-contact determination of the shape of the dental technology object, whereby the constructive effort to determine the spatial coordinates is kept low and the shape acquisition should still be performed highly precisely and at high speed, it is provided that the matrix camera is a color matrix camera with first, second and third pixels, that the matrix camera captures light in a range of wave lengths characteristic for one type of the pixels (first pixels) and the values at least of one of the other types of the pixels (second and third pixels) are analyzed to determine the two first location coordinates (Y- and Z-coordinates).

The invention relates to a method for the non-contact three-dimensional determination of shape of a dental technology object such as a positive model or a section thereof, whereby, to determine the spatial coordinates of the object's surface points to be measured, a strip of light projected onto the object is measured by at least two matrix cameras to determine two space coordinates (Z- Y-coordinate) of a coordinate system, and by determining the position of the object arranged on a measuring table rotatable about an axis of rotation, the third spatial coordinate (X coordinate) is determined. Furthermore, the invention relates to an apparatus for the non-contact three-dimensional determination of shape of a dental technical technology object, such as a positive model or a section thereof, comprising a measuring table receiving the dental technical technology object and rotatable about an axis of rotation, a light-generating means such as a laser device for projecting a line of light onto the dental technical technology object, two matrix cameras oriented towards the line of light as well as an analysis unit analyzing signals of the matrix cameras for the determination of the coordinates of the line of light.

A method of the type specified at the outset can be found in DE-A-43 01 538. This, according to one embodiment, involves using two CCD matrix cameras forming an acute angle to apply the triangulation principle to determine the height value (Z-axis) of a dental technical technology object arranged on a rotary table. The value of the Y-coordinate, extending vertically relative to the Z-axis, is obtained by means of the strip light projected onto the dental technical object. The third space coordinate (X-coordinate) is supplied by the rotary table. To produce the strip light a diode laser, a coordinate optical system and a cylinder lens arrangement are used. For this purpose control inputs are tapped.

Measurements have shown that the data necessary for the production of a dental prosthesis to be placed on or inserted into a dental technical technology object or a section of it are not sufficiently precise and are not obtained in the required speed. One reason among others for this is that the determination of the space coordinate provided by the position of the rotary table is insufficiently precise or involves substantial effort.

The DE-A-101 33 568 discloses a method for three-dimensional measurement of a dental technical technology object. In this case, the object is clamped in a holding means in a defined orientation, irradiated and the reflected radiation evaluate analyzed, whereby the object is moved both translationally and rotationally relative to a source of radiation to carry out the measurement.

The present invention is based on the problem of improving a method and an apparatus of the type stated at the outset in such a manner that an easy non-contact shape determination of the dental technology object becomes possible, whereby the constructive effort to determine the space coordinates is kept low and the shape acquisition should still be performed highly precisely and at high speed.

To solve the problem, the invention essentially provides that the matrix camera is a color matrix camera with first, second and third pixels, that the matrix camera captures light in a range of wave lengths characteristic for one type of the pixels (first pixels) and the values of at least one of the other types of the pixels (second and third pixels) are analyzed to determine the two first location coordinates (Y- and Z-coordinates).

It is especially provided that the matrix camera is exposed to light whose radiation is characteristic of the red pixels as the first pixels, preferably in the wave length spectrum of approximately 635 nm. In the process the matrix camera should be exposed to an illuminance (intensity of illumination) which leads to an overcharging, i.e. overexposure. These measures not only excite the pixels especially sensitive to the incoming radiation (the first pixels), but also the other pixels, i.e. for a range of wave lengths, adapted to the red pixels, of the incoming radiation of the green and blue pixels, to then evaluate analyze at least one type of these pixels—especially the pixels excited by green. This permits a precisely positioned determination of the line falling on the dental technology object, such as a laser line, and thus a high resolution. In addition, filters can be provided for to eliminate any intrinsic disruptive light in the laser light.

The dental technology object is then rotated on the measuring or rotary table around the axis of rotation, whereby step angles of 1° are preferred. Other angles are also possible. After capturing the individual light sections, the corresponding images are transformed to the rotational axis, in order to then combine the transformed images into the object to be imaged in digital form.

The step angles can also be realized by capturing the object at a constant rotational speed at a fixed image sequence frequency. This measure is the equivalent to the rotation of the measuring table by defined step angles.

To carry out the transformation, a rod or pin of known dimensions is firstly detected in the individual angular positions, the rotational axis coinciding with the longitudinal axis of the pin or rod.

In other words, the images of the pin or rod are used for the transformation of the measurement results of the individual light sections of the dental technical technology object onto the rotary axis.

The coordinates of the light sections are obtained based on a previously executed calibration, which is explained below.

According to one inventive proposal, the two matrix cameras, which are preferably CMOS matrix cameras, are oriented symmetrically relative to a plane in which the rotational axis of the measuring table is located, the cameras being additionally oriented in such a manner relative to a flat calibrating body that the camera images are identical, said calibrating body is being arranged in the plane which extends centrally through the calibrating body.

According to another inventive proposal, the obtuse angle (Scheimpflug angle) of the chip surfaces, i.e. the angle of the matrices of the cameras, is set relative to the optical axis in such a manner that the surfaces of the calibrating body are sharply imaged.

However, due to the slanted orientation of the matrices, distorted images are captured. The rectification is then carried out by means of a suitable software. For example, if there are circles on the side of the calibrating body to be imaged, on the chip surfaces deformed circles are imaged which are converted by the software into circles in order to compensate this imaging error. In this way then, a unique coordinate is allocated to each pixel. The calibrating data obtained in this way are then the basis of evaluating the light section.

The inherently stiff, flat calibrating body can also be used to calibrate the light line (e.g. laser line), whereby the laser line is emitted parallel to the plate and in the middle of the edge of the calibrating body facing the camera. The laser line itself should be spread in such a manner that the edge rays form an angle of between 10° and 30°, preferably 20°. In other words, the line passes through the rotational axis of the rotary or measuring table, which moreover lies in the plane defined by the spread measurement ray.

If, in this way, the measuring head, consisting of the cameras (preferably CMOS matrix cameras) and the source of the line ray, is calibrated, it can be built in.

The above-described measures have the overall result of rectifying the distortion of the camera images as well as adjusting the line in reference to the rotational axis. Then, the light-section method is performed, whereby the rotational axis of the measuring table must pass through the area of the dental technology object which is to be measured.

If not only a spatially limited area of a dental technology object, such as a stump, is to be measured, but rather a larger field, the dental technology object must be replaced several times on the rotary table to permit the rotational axis of the measuring table to pass through the partial area which is to be measured. To make the individual measurements as a function of the position of the dental technology object, i.e. to be able to connect with each other the scatter plots measured in the individual position, the relationship between the individual position of the object and rotational axis must be known.

Hence, an additional inventive proposal of the invention provides that above the measuring table an additional camera (reference camera) is arranged whose optical axis is oriented along the rotational axis of the measuring table, and that the measuring table or a holding means, holding the object and arranged on the measuring table, is provided with a referencing means by which the images of the dental technology object, arranged on the measuring table in various positions, are correlated, i.e. combined precisely positioned.

This camera can also be used for orienting the dental technology object, or the object section to be measured, relative to the rotational axis, if a marker representing the rotational axis is superimposed onto the image captured by the camera. This marker can preferably have the shape of a cross.

To permit a sufficient illumination of the dental technology object, provision has been made for the objective of the referencing camera to be surrounded by a luminous ring—preferably consisting of light-emitting diodes—by means of which the object is adequately illuminated.

The referencing means and the reference camera are consequently used to simply determine the relative position of the dental technology object with respect to the rotational axis of the measuring table and, thus, to the matrix cameras and, as a result, the space coordinate of the individually captured measuring point as well. To this end, the referencing means is used which is located at the element from which the dental technical technology object to be measured extends directly, preferably at the holding means which can be attached to the rotary table. When the rotary table is rotated, the referencing means moves in a circular path around the center point of the rotational axis. Detecting the relative shifts and rotations of the referencing means relative to the reference camera permits a highly precise location determination of the individual position of the dental technical technology object so that subsequently the measured values, i.e. the scatter plots, can be easily linked to the optical displays of the dental technology object.

From the position of the angular setting of the rotary table, the referencing means captured by the reference camera, and the positions of the matrix cameras relative to the rotational axis, the space coordinates of each measuring point can then be determined.

The holding means itself is in particular adjustable rotatably, tiltably and also in height, and can be locked into place in the selected orientation relative to the reference camera, whereby a positioning occurs in such a manner that the section of the object to be-measured and to be fitted with a dental prosthesis is penetrated by the rotational axis.

It is provided, in particular, that the dental technology object to be measured and to be fitted with a dental prosthesis is oriented relative to the rotational axis in such a manner that the direction of insertion or removal of the dental prosthesis to be made runs extends parallel or approximately parallel to the rotational axis and, thus, to the optical axis of the reference camera.

Especially good measurement results with a high resolution, i.e. a precise measurement of the coordinates of the measurement line such as a laser line, are obtained if the dental technology object is irradiated with a light, or light is determined by the matrix cameras, in a wave length spectrum which excites the red pixels. In this context, the radiation intensity is set so that relative to the red pixels an overcharging, i.e. an overexposure, results but in so doing the other pixels are also excited and of these the green pixels are preferably analyzed to determine the coordinates of the measurement line.

An apparatus of the type specified at the beginning is characterized in that the matrix cameras are color-matrix cameras, whereby the matrix cameras are exposed to light within a wavelength spectrum that is characteristic for a first type of pixel, and that the charge values of a second type of pixels, different from the first type of pixels, can be analyzed for the measurement of the light line.

Independent of this, the use of two matrix cameras makes it possible to determine sections where the reflected laser line is not visible to one of the cameras. An increased measurement precision is obtained in the sections which are observed simultaneously by both matrix cameras.

A further embodiment of the invention, which is to be emphasized, provides that, above the measuring table, there is a reference camera arranged for determining a referencing means present on the measuring table or on a holding means arranged on it. In this case, in particular the dental technical technology object is arranged on the holding means in order to be moved simply to the rotational axis of the measuring table. In this case the holding means can be made adjustable rotatably, tiltably and in height.

The matrix cameras are especially CMOS color-matrix cameras, whereby preferably the signals are analyzed which are emitted by the green pixels.

The optical axes of the two matrix cameras run extend relative to each other at an angle γ of 60° to 90°, especially at an angle γ of 80°, whereby the optical axis of each matrix camera to the vertical should form an angle α1, α2 of 30°≦α1, α2 of ≦60°, whereby in particular α1=α2.

Regarding the light strip, i.e. the light line, such as a laser line, projected onto the object, the unit used for this purpose should comprise at least one laser, such as a diode laser, and an optical lens. The spread ray should form an angle β of 10°≦β≦30°. In this context, the center ray of the light line in particular, extends along the bisector of the optical axes of the CMOS cameras, i.e. in the plane which is defined by the optical axes. The center ray subtends with the vertical the angle δ, which is equal to α1 or α2.

Further details, advantages and features of the invention arise not only from the claims, the features they include—alone and/or in combination—, but also from the following description of preferred embodiments shown by the drawing, in which:

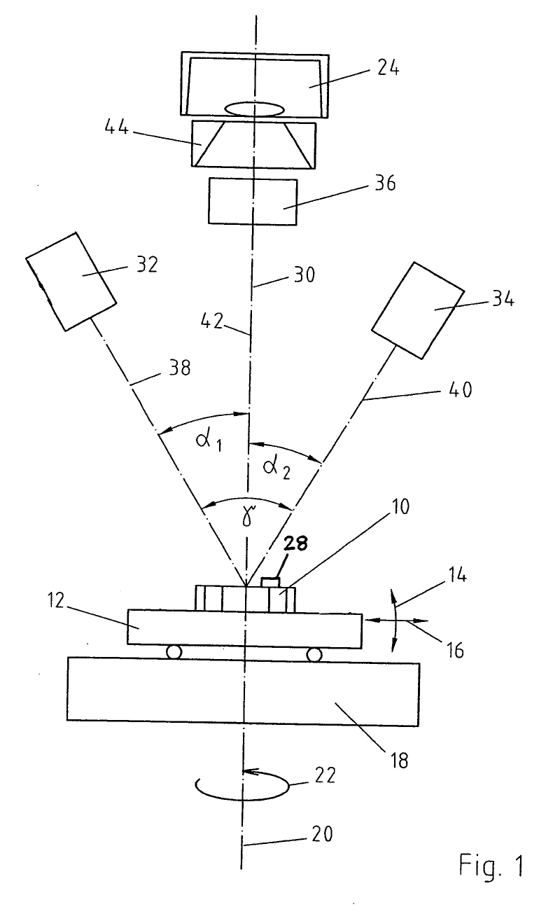

FIG. 1 shows a schematic diagram of a measuring apparatus in front view,

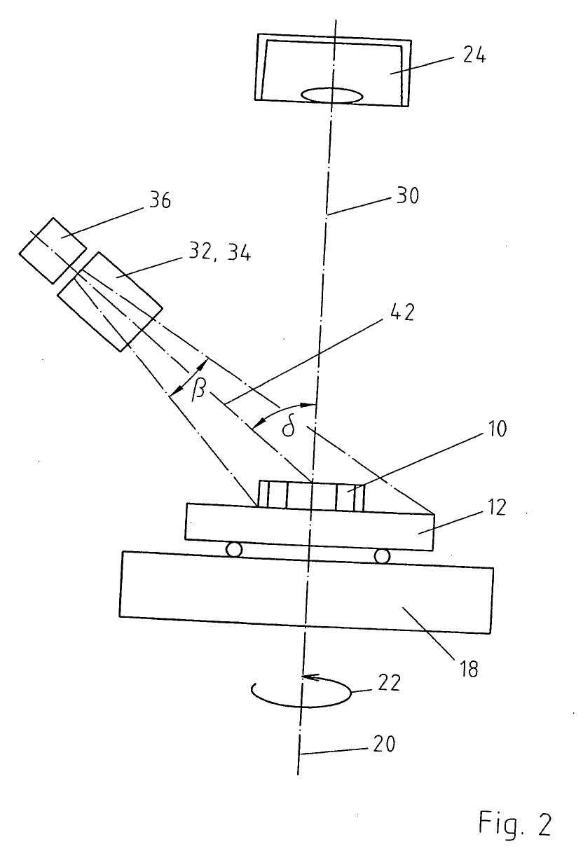

FIG. 2 shows the measuring apparatus according to FIG. 1, rotated 90° (side view),

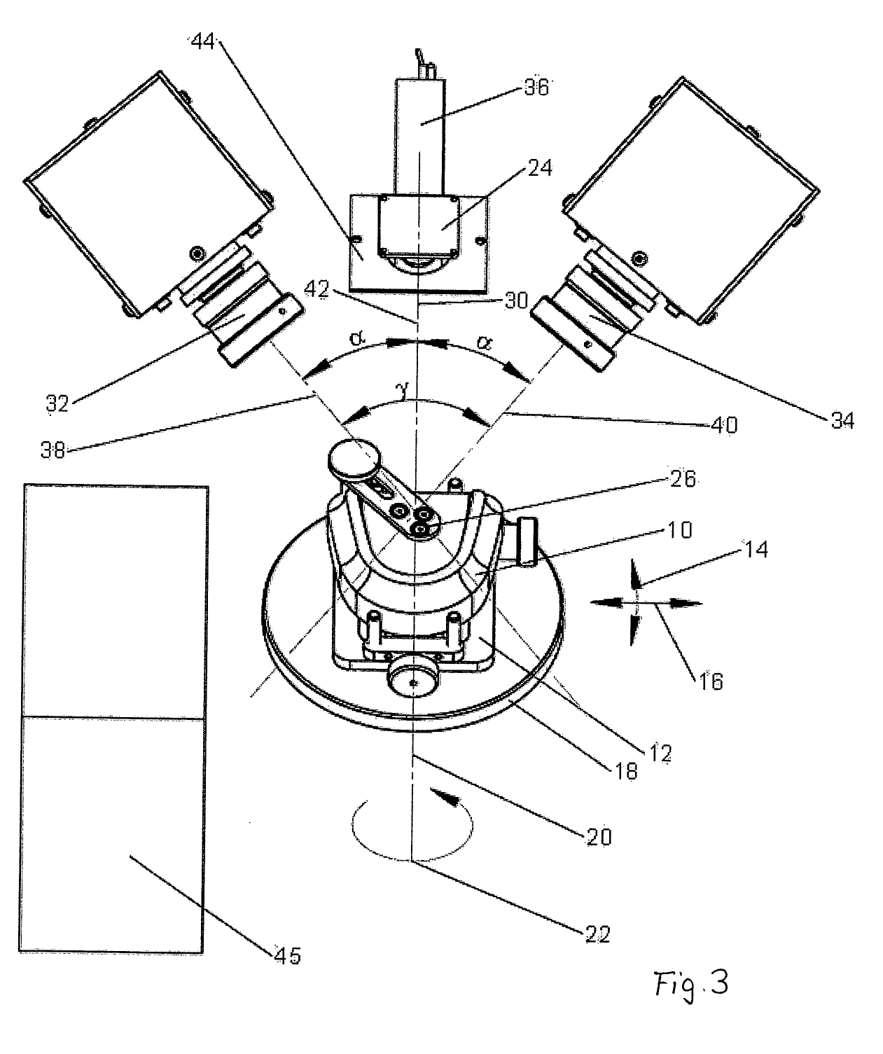

FIG. 3 shows a perspective representation of a measuring apparatus according to FIG. 1,

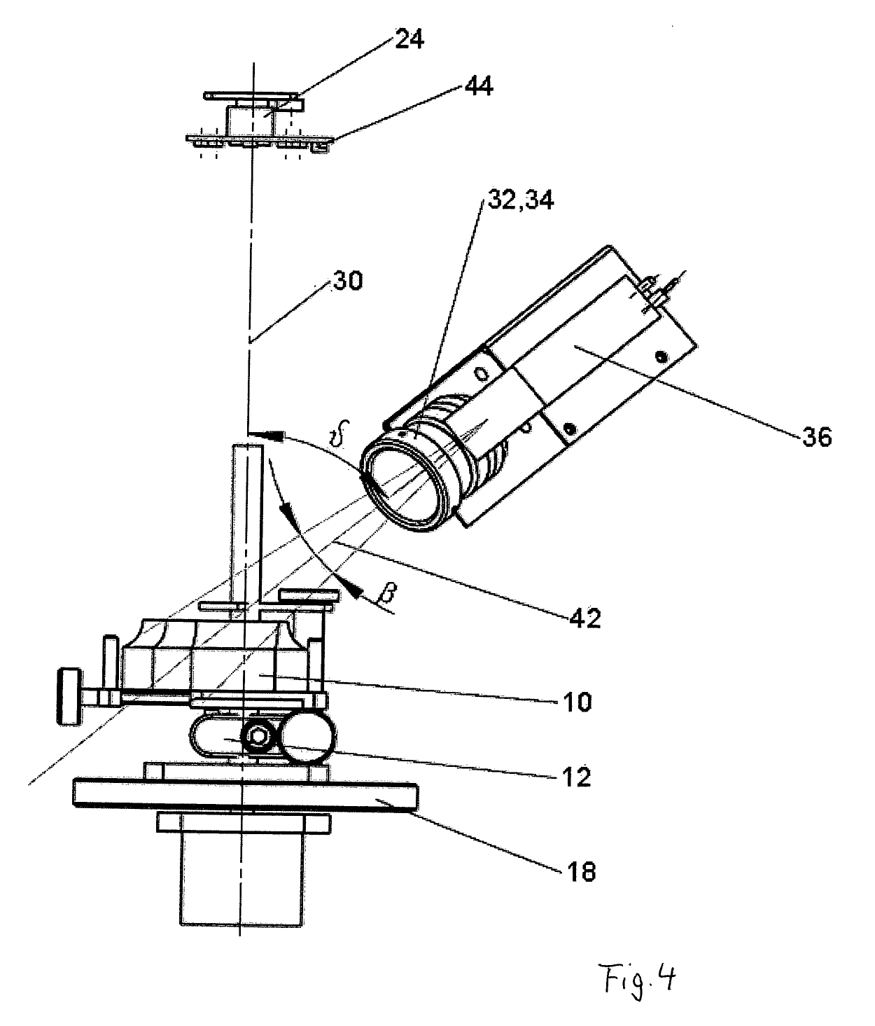

FIG. 4 shows the measuring apparatus according to FIG. 3, rotated 90°,

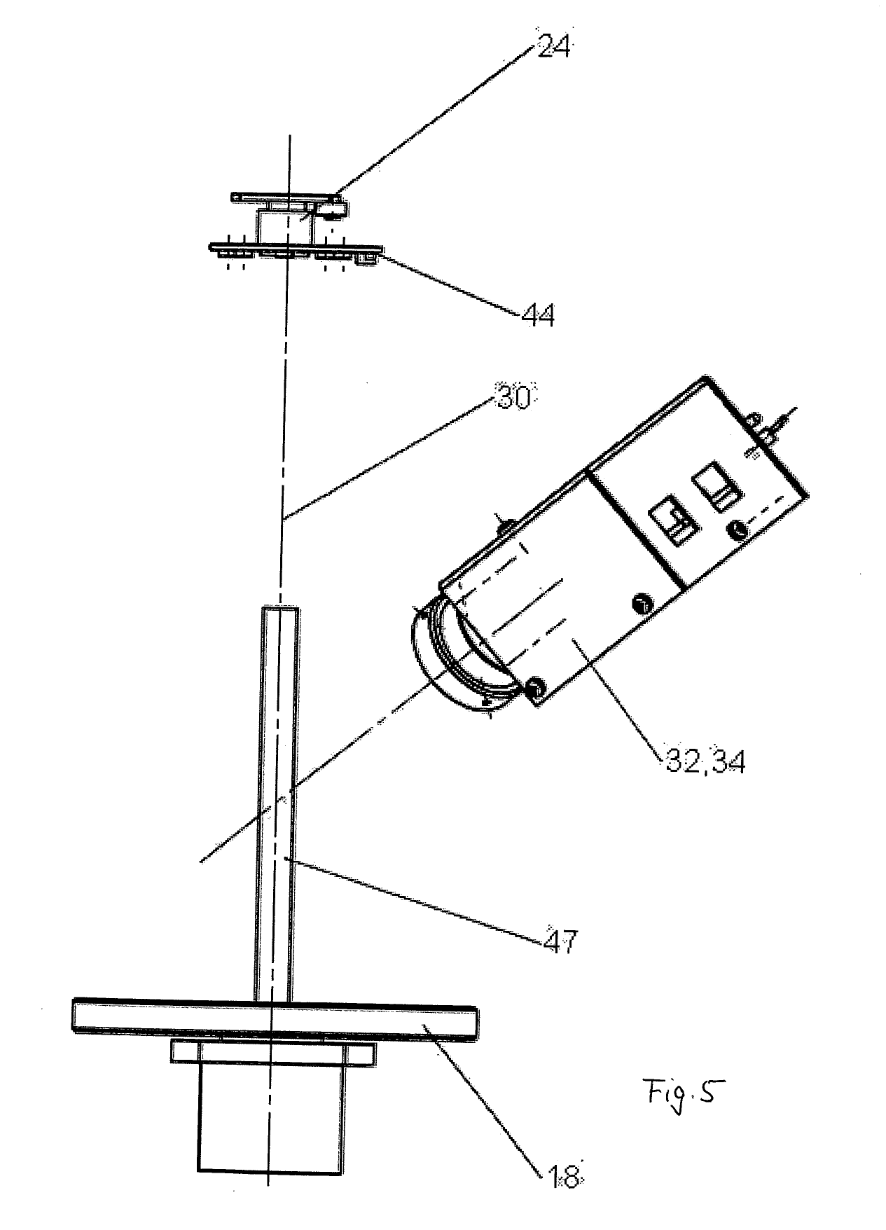

FIG. 5 shows a detail of FIG. 3 with a calibrating rod,

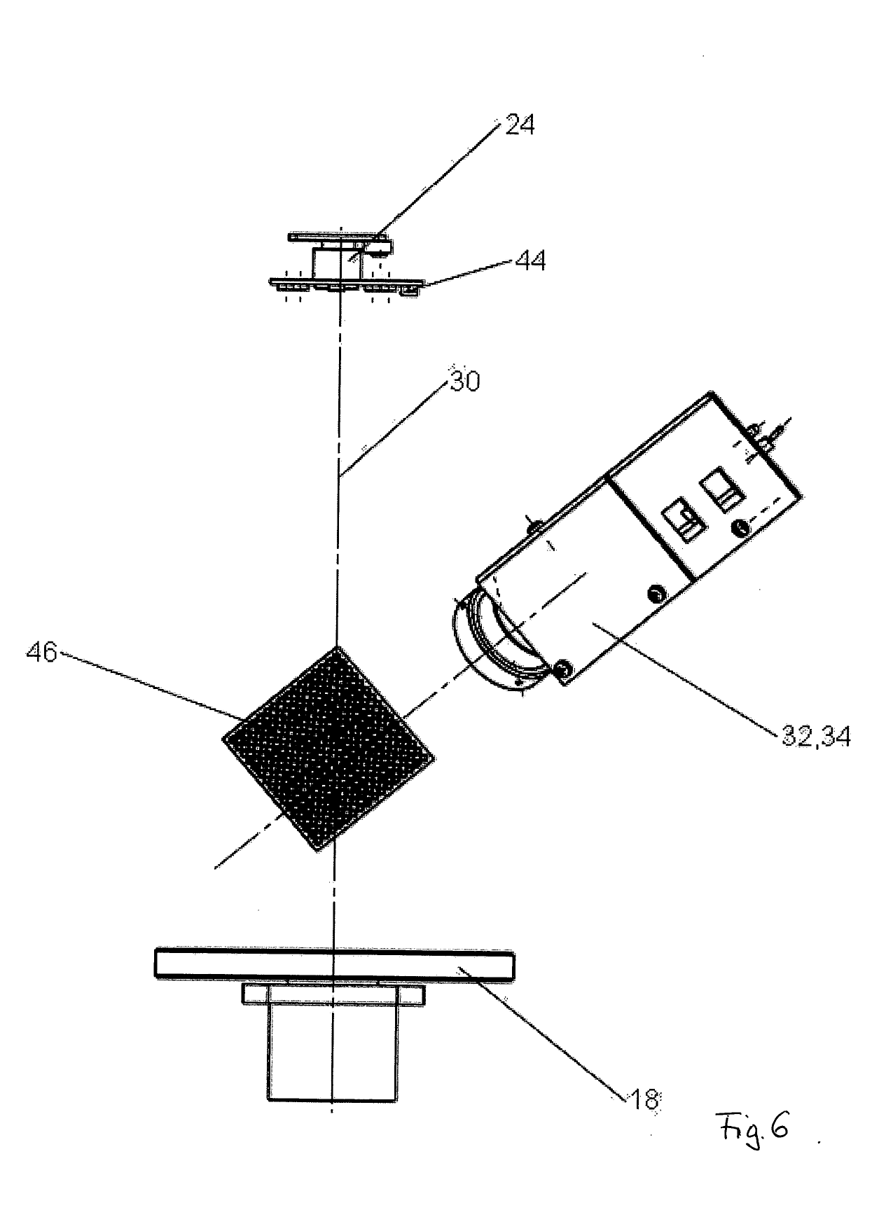

FIG. 6 shows a detail of the measuring apparatus according to FIG. 3 with a calibrating body, and

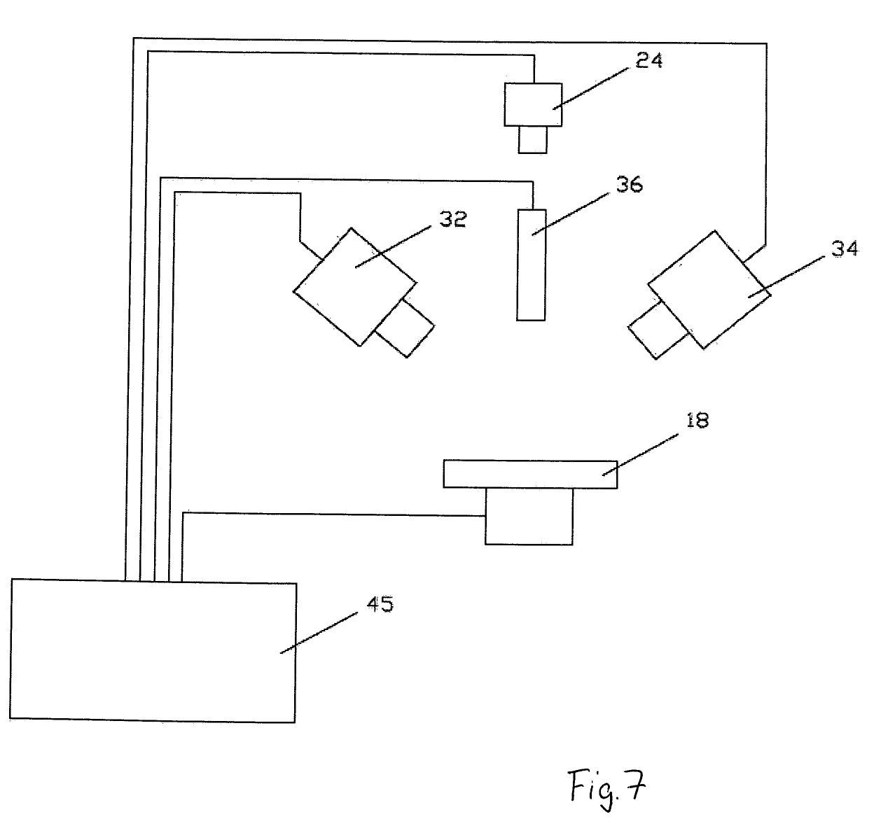

FIG. 7 shows a block diagram.

The Figures show diagrammatic representations of an apparatus for non-contact shape determination of a dental technology object in different views and perspective representations, partially in detail, where identical elements are marked with identical reference numbers, even if elements deviate from each other as to their graphics, but imply the identical technical information content. In the embodiment shown in the Figs. the dental technology object is a positive model 10, without a restriction of the invention thereby occurring.

The positive model 10 is arranged on a holding means 12 which, as shown by arrows 14 and 16, is displaceable, tiltable and height adjustable relative to a measuring or rotary table 18. The rotary table itself is rotatable about an axis 20 (arrow 22). Above the rotary table 18, a referencing camera 24 is arranged by which the rotary table 18 or the field, in which the positive model 10 is attached by means of the holding means 12 on the rotary table 18 in the desired position and orientation, can be captured.

Furthermore, markings 26, which form a reference means, extend from the holding means 12, by which means the position of the holding means 12 and, hence, of the positive or plaster model 10 relative to the rotational axis 20 can be ascertained. The markings 26 are preferably three point-, circular-, disc- or line-shaped indicators arranged on the surface of the holding means 12.

The optical axis 30 of the referencing camera 24 coincides—as the drawing shows—with the rotational axis 20 of the rotary table 18. The rotary table 18 is rotated step-by-step, preferably by an angle of 1° in each case, by which one coordinate (X-coordinate) of the dental technical technology object 10 to be measured is preset. The remaining (Y- and Z-) coordinates of the individual measuring point to be captured are obtained by two CMOS matrix color cameras 32, 34, which measure a ray beam of light projected onto the positive model, which beam is preferably emitted by a laser unit 36. This can comprise a diode laser with a collimator lens and a cylinder lens arrangement. However, in this context, reference is made to constructive solutions which are known from arrangements which are used for light-section methods. The laser light preferably used is one whose radiation is concentrated in one wave-length range which is characteristic for the excitement of the red pixels of the CMOS matrix color camera 32, 34. Preferably, a radiation should be used which is concentrated in the vicinity of 635 nm.

The optical axes 38, 40 of the matrix color cameras 32, 34 can subtend an angle γ of preferably γ∞80°, whereby the individual optical axis 38, 40 should subtend relative to the vertical, which coincides in the drawing with the optical axis 30 of the referencing camera 24, an angle of α1 or α2 of 30°≦α1, α2≦60°. In particular, the CMOS matrix cameras 32, 34 are symmetrically arranged relative to axis 30.

As can be seen in FIGS. 2 an and 4, the laser unit 36 lies in the plane defined by the matrix color cameras 32, 34. As a result, the center ray 42 of the laser unit 36 subtends an angle δ, corresponding to α1 or α2, relative to the vertical, which is determined by the optical axis 30 of the referencing camera 24. Furthermore, the laser unit 36 is oriented in such a way relative to cameras 38, 40 that the divergent beam is in a plane in which extends the bisector between the optical axes 38, 40 of the matrix color cameras 32, 34.

The ray of light of the laser unit 36 is preferably divergent by an angle β, where 10°≦β≦30°, preferably β∞20°.

For the measurement, the measuring table 18 is preferably rotated around the axis 20 by a total of 360°, in steps of preferably 1° each, to measure the light strip in every position by means of the matrix cameras 32, 34 (measurements at a preset overall angle such as 360° are in total 1 scan) in order to determine both the Y- and the Z-coordinates of the individual measuring point of the section of the plaster model 10 which is to be measured. In this context, the plaster model 10 is preferably oriented relative to the rotational axis 20, and hence to the optical axis 30 of the referencing camera 24, in such a manner that the optical axis passes through the center point of the area, which is to be measured, of the plaster model.

To the extent that the referencing means (marking 26) is necessary for the measurements, it must be clearly recognizable. For this purpose, the objective of the referencing camera 24 can be concentrically enclosed in a luminous ring 44, preferably consisting of diodes, by means of which the holding means 12 is illuminated.

The following approach must be taken in order to measure the positive model 10 or the area or section to be provided with a dental prosthesis, using the corresponding apparatus illustrated by the, in a form which is purely in principle, in FIGS. 1 and 2 or 3 and 4.

Firstly, the plaster model 10 to be measured, which corresponds to the situation in the mouth of the patient, is oriented on and attached to holding means 12, which is also referred to as a model holder. The orientation occurs in such a way that the insert direction of insertion of the dental prosthesis to be designed is parallel to the axis of rotation 20 of the rotary table 18 and, thus, parallel to the optical axis 30 of the referencing camera 24. Thereby, the rotational axis 20 and, hence, the optical axis 30 of the referencing camera 24 should pass through the center point of the area or the section of the plaster model or positive model 10 to be measured.

If necessary, adjacent areas of the area to be measured can be exposed to prevent any shadows.

The model holder 12 is shifted until the center point of the model position to be measured coincides with the rotational axis 20. Then the model holding means 12 is locked on the rotary table 18.

To facilitate the orientation, the image captured by the referencing camera 24 is displayed, together with a superimposed axes cross crosshair, on a monitor through the center point of which is passed through by extends the rotational axis 20.

Then, the scan procedure is started by an operator. For this purpose the rotary table 18 is firstly rotated automatically into a start position, although any position of the rotary or measuring table 18 can basically be selected as a starting position. For the step-wise rotation of the rotary table 18 (in each case preferably by 1°), the tooth or hole position to be measured is rotated under the light or laser line projected by the laser assembly 36 and synchronous images of the reflected light line are obtained by the two matrix color cameras 32, 34.

Then, after one run (preferably 360°; 1 scan or individual scan), the Y- and Z-co-ordinates of the surface of the tooth or hole position are determined according to the light-section method from these images and the respective angle of rotation, that for example can be determined by a step motor. The missing X co-ordinate is obtained from the respective position of the measuring table 18.

Alternatively, the rotary table 18 can be rotated at a constant rotational speed and the plaster model 10 can be imaged at a fixed image sequence frequency.

In order to be able to measure a model section comprising several tooth or hole positions, several such scan procedures (individual scan procedures) must generally be carried out.

In order to be able to display the whole surface of a large model section or even the whole model in one uniform coordinate system, the individual scans, i.e. the point clouds of the individual measurements, are then connected. For this purpose the reference markings 26, 28, which can be present on the model holder 12, are significant since through these a geometrical allocation of the individual positions of the plaster model 10 to the rotational axis 20 of the measuring table 18 is made possible; because with each scan the reference markings 26, which are on the model holder 12, describe circular paths around the rotational axis 20 which are captured by the referencing camera 24. Changes in the position or the diameters of the circles for the individual measurements are a unit of measurement for the shifts made between the measurements. Hence it is possible to convert the data of all the individual scans, i.e. of the values obtained in one run, whose sets of coordinates are dependent on the respective orientation of the model holder 12, in a common coordinate system.

The exposure of the matrix cameras 32, 34 to a radiation in which basically only one of the pixel types is excited and, then, the evaluation of the pixels of another type, whereby the irradiance (level of radiation) is set so high that an overloading or overexposure results, leads to a large useable dynamic area for the recognition of the center and the border areas of the reflected laser line, i.e. the laser line is highly precisely determined.

To achieve a high resolution, provision has been made for only the green fractions of the pixels of the CMOS matrix color cameras 32, 34 to be evaluate analyzed, if the matrices are exposed to a ray whose wave-length spectrum is characteristic for the excitement of red pixels. Instead of the green pixels, the blue pixels can also be analyzed.

If one also takes into account the arrangement of the subpixels to each other (e.g. Bayer pattern), i.e. compensates the corresponding geometrical mismatch of the subpixels during the evaluation of the red, green or blue images, the precision of the coordinate determination can be enhanced even more.

To calibrate the matrix cameras 32, 34, an orientation occurs relative to a calibrating body 46 which is a flat, preferably rectangularly shaped body (FIG. 6), from which a respective one of the sides is captured by one of the matrix cameras 32, 34. In this context, a calibrating body is used whose thickness is smaller than the depth of focus of the respective matrix camera 32, 34.

The matrix cameras 32, 34 are then oriented is such a way that the images of the respective sides of the calibrating body are identical.

By the slanted orientation of the matrices, i.e. by the obtuse angle (Scheimpflug angle) of the matrices, which deviates by 90° relative to the normal of the respective side, a distortion of markings, such as circles, present on the sides of the calibrating body is caused. This distortion is rectified by software. Then, one coordinate can be allocated to each pixel of the matrices.

To transform onto the rotational axis of the rotary table 18 the images captured in the respective angular positions of the rotary table 18, images of a calibrating rod or pin 47 (FIG. 5), which extends along the rotational axis 20 and the optical axis 30 of the reference camera 24 and through which extends the axis 20 or 30, are also taken by the matrix cameras 32, 34. The corresponding images of the pin or rod 47 are used for the transformation of the measurement results, i.e. the images of the laser line, imaged on the plaster model 10, onto the rotary table axis 18. In this connection, the cross-section of the calibrating pin 47 needs to be considered, too.

With a suitable analysis unit, the digital values are then calculated, on the basis of the measurement results of the CMOS matrix cameras 32, 34, taking into account the above-described transformation as well as the orientation of the rotary table 18 or of the positions of the dental technology object to be measured, which can be captured by means of the referencing means 26, on which basis the desired dental prosthesis is manufactured, as is customary, using CAD-CAM procedures. In this connection, reference is made to the implementation possibilities disclosed in EP-B-0 913 130 or WO-A-99/47065.

FIG. 7 discloses a representation equivalent to a block diagram for clarifying the connection of the elements for a non-contact, three-dimensional determination of the shape of a the dental technology object 10. Thus, the rotary table 18, the matrix cameras 32, 34, the reference camera 24 as well as the laser unit 36 are connected to the control and evaluation unit 45 to measure, by means of the matrix cameras 32, 34, the dental technology object arranged on the measuring table 18 and rotatable around its rotational axis 20, whereby the position of the holding device 12 receiving the dental technical technology object 10 can be determined by means of the reference camera 24. By means of the laser unit 36, the dental technology object 10 is exposed to a light strip. The individual measuring values are then linked by the analysis unit 45, taking into account of the aforementioned calibration, to have available then in digital form the co-ordinates of the dental technology object 10, on the basis of which then a dental prosthesis can be produced using the CAD-CAM method.

1. Method for a non-contact, three-dimensional determination of the shape of a dental technical technology object, such as a positive model (10) or a section of it, whereby, to determine the spatial coordinates of surface points of the object to be measured, a strip of light projected onto the object is measured by at least two matrix cameras (32, 34) to determine two coordinates (Z-, Y-coordinate) of a coordinate system, and a third co-ordinate-co-ordinate) is determined by capturing the position of the object arranged on a measuring table (18), which can rotate around a rotational axis (20), characterized in that the matrix camera (32, 34) is a color matrix camera with first, second and third pixels, that light is detected by the matrix camera in a wave length range substantially characteristic for one type of the pixels (first pixels), and values of at least one of the other types of the pixels (second and third pixels) are analyzed to determine the two first coordinates (Y- and Z-coordinates).

2. Method according to claim 1, characterized in that the matrix camera (32, 34) is exposed to a radiation in the wave-length range characteristic for the red pixels as the first pixels, preferably in the wave-length range of approximately 635 nm.

3. Method according to claim 1, characterized in that the matrix camera (32, 34) is exposed to a radiation intensity which leads to an overcharging of the first type of pixels.

4. Method according to claim 1, characterized in that the object is exposed to a radiation in a wave-length range characteristic for the first pixels.

5. Method according to claim 1, characterized in that, as the other type of pixels, the green pixels are analyzed.

6. Method according to claim 1, characterized in that the camera (32, 34) used is a CMOS camera.

7. Method according to claim 1, characterized in that the matrix cameras (32, 34) and/or their matrices (chip surfaces) are oriented symmetrically relative to a plane in which the rotational axis (20) of the measuring table (18) lies, and that the matrix cameras or matrices are oriented in such a way, relative to a flat calibrating body (46), that the images are identical, the calibrating body is being arranged in the plane and being centrally traversed by it.

8. Method according claim 1, characterized in that the matrices (chip surfaces) of the matrix cameras (32, 34) are so oriented relative to a flat, rectangular calibrating body (46), of which a respective side is measured by one of the matrix cameras, that the individual image of each camera taken from the respective side is combined into a complete image, which has a rectangular form, without overlapping of the individual images.

9. Method according claim 1, characterized in that to transform the images of the object (10) taken by the matrix cameras (32, 34) into the coordinate system (X-, Y-, Z-coordinates), a comparison of these is performed with the images of a standard body (47) which is traversed by the rotational axis (20).

10. Method according to claim 9, characterized in that as standard body (47) a pin or rod with, for example, a circular or polygonal, for example square-shaped, cross-section is used whose longitudinal axis corresponds to the rotational axis (18) of the measuring table (20).

11. Method according to claim 1, characterized in that, above the measuring table (18), a referencing camera (24) is arranged whose optical axis (30) is oriented along the rotational axis (20) of the measuring table (18) and that the measuring table or a holding means (12), receiving the object and being arranged on the measuring table, is marked with a referencing means (26), by which positions, in which the object is arranged on the measuring table, are determined relative to each other.

12. Method according to claim 1, characterized in that the matrix cameras (32, 34) are oriented in reference to each other in such a way that their optical axes (38, 40) intersect each other at an angle γ at 60°≦γ≦90°.

13. Method according to claim 11, characterized in that the holding means (12) which is provided with the referencing means (26) and holds the dental technology object, is attached on the measuring table (18) and that the third coordinate is determined from the rotational position of the measuring table.

14. Apparatus for the non-contact, three-dimensional determination of shape of a dental technology object (10), such as a positive model or a section thereof, with a measuring table (18) receiving the dental technology object and rotatable about an axis of rotation (20), a light-generating apparatus (36), such as a laser apparatus, for imaging a line of light onto the dental technology object, two matrix cameras (32, 34) oriented towards the light line, and an analysis unit (45) analyzing signals from the matrix cameras to determine co-ordinates of the light line, characterized in that the matrix cameras (32, 34) are color cameras, whereby the matrix cameras are exposed to light in a wave-length range which is characteristic for one type of the pixels, and that the loading values of a second type of the pixels, which are different from the first type of the pixels, can be analyzed to measure the light line.

15. Apparatus according to claim 14, characterized in that, above the measuring table (18), a referencing camera (24) is arranged to detect at least one referencing means (26) which is associated with the position of the dental technology object (10) on the measuring table.

16. Apparatus according to claim 14, characterized in that the dental technology object (10) is positioned on a holding means (12), which can be arranged on the measuring table (18), with the referencing means (26) which is to be captured by the referencing camera (24).

17. Apparatus according to claim 16, characterized in that the holding means (12) is made displaceable and/or tiltable relative to the measuring table (18).

18. Apparatus according to claim 14, characterized in that the matrix camera (32, 34) is a CMOS colour matrix camera.

19. Apparatus according to claim 14, characterized in that optical axes (38, 40) of the two matrix cameras (32, 34) intersect at an angle γy, where 60°≦γ≦90°.

20. Apparatus according to claim 19, characterized in that the optical axis (38, 40) of the matrix camera (38, 40) subtends with the vertical an angle a1, a2 of where 30°≦a1, a2≦60°.

21. Apparatus according to claim 14, characterized in that the aperture angle b of the light generating apparatus (36) is in the range 10°≦b≦30°, especially b=20°.

22. Apparatus according to claim 15, characterized in that the reference camera (24) features a luminous ring (44) oriented towards the measuring table (18) and concentrically surrounding its optical system.

23. Apparatus according to claim 14, characterized in that the matrices (chip surfaces) are oriented in such a manner, relative to their obtuse angles that the respective image captured from each side of a flat calibrating object is homogenously sharply imaged, whereby the calibrating body is oriented in such a manner relative to the rotational axis (20) of the measuring table (18) that it extends within the calibrating body, and the calibrating body has thickness which is equal to or smaller than the depth of focus of the respective matrix camera (32, 34).
